(19) United States
(12) Patent Application Publication
(10) Pub. No.: US 2012/0131959 A1
(43) Pub. Date: May 31, 2012

(54) LASER SEALING DEVICE FOR GLASS SUBSTRATES

(75) Inventors: Donghun No, Cheongju-si (KR); Hyun Young Cho, Daejeon (KR)

(73) Assignee: LG HAUSYS, LTD., Seoul (KR)

(21) Appl. No.: 13/389,346

(22) PCT Filed: Nov. 16, 2010
(86) PCT No.: PCT/KR2010/008103

§ 371 Date: Feb. 7, 2012

(30) Foreign Application Priority Data
Nov. 17, 2009 (KR) 10-2009-0111161

(51) Int. Cl. C03C 27/12

(52) U.S. Cl. 65/43

(57) ABSTRACT

A laser sealing device for glass substrates includes a first laser head and a second laser head. The first laser head irradiates laser onto a sealing material coated between glass substrates, thereby melting the sealing material. The second laser head is provided at a predetermined interval from the first laser head, irradiates laser onto the portion which has been irradiated by the first laser head, and is set to a lower power than the first laser head. The device further includes a heating plate provided so as to be movable relative to the first and second laser heads and placed on the glass substrates when being heated to a predetermined temperature. Thus, it is possible to minimize the occurrence of cracking in the glass substrates due to thermal shock since the temperature of the sealing material which is melted by the laser heads drops slowly rather than rapidly.

### TECHNICAL FIELD

The present disclosure relates to glass substrates, and more particularly relates to a laser sealing device for glass substrates, which includes two laser heads having different temperatures so as to prevent the occurrence of cracking in the glass substrates during a process of sealing the glass substrates.

### BACKGROUND

Transparent conductive glass substrates are used not only for solar cells, display panels and relative materials, components and equipment but also for double vacuum glass. The conductive glass substrates are provided with electrodes capable of preventing gas from being leaked to the outside of the conductive glass substrates and being easily oxidized and degraded by oxygen or moisture in the inside of the conductive glass substrates. Therefore, it is important to prevent oxygen or the like from penetrating into the conductive glass substrates from the outside.

Conventionally, there were frequently used two methods for sealing and bonding conductive glass substrates. In the first method, the conductive glass substrates are sealed and bonded using a polymer adhesive. In the second method, the conductive glass substrates are sealed with a glass frit that is a ceramic or glass bonding material and then bonded by heating the glass frit in a high-temperature sintering furnace.

Among these methods, the method using the glass frit that is a sealing material has excellent sealing performance for preventing leakage of gas as compared with the method using the polymer adhesive.

However, the conventional methods described above have the following problems.

In the conventional methods, the glass frit is melted by being irradiated with laser in the state that the glass frit is coated between the glass substrates. There is a problem that cracks occur in the glass substrates in the process in which the glass frit is melted and the temperature of the glass frit then drops.

More specifically, referring to FIG. 1, a change in temperature of a glass frit melted by being irradiated with laser according to time is shown in FIG. 1. For reference, the laser having a power of 9 W and a beam size of 1 mm is used in this figure. It will be apparent that the power and beam size of the laser may be changed depending on the sintered state and coated width of the glass frit.

As can be seen in this figure, the temperature of the glass frit rapidly rises between 2 and 3 seconds upon irradiation with a laser. That is, the temperature of the glass frit is maintained at about 30° C. and then rises up to a maximum of 550° C. for only 0.5 seconds upon irradiation with a laser.

It can be seen that the temperature of the glass frit drops to 100° C. within only 2.9 seconds after irradiation with a laser. As described above, the glass frit quickly cools down after irradiation with a laser, and therefore, it is highly likely that cracks occur in the glass substrates due to thermal shock. Even if cracks do not occur, the durability of the glass substrates may be weakened, and therefore, failure may occur in the glass substrates.

### SUMMARY

The present disclosure provides some embodiments of a laser sealing device for glass substrates, which can improve durability of the glass substrates by minimizing the occurrence of cracking in the glass substrates in a bonding process of the glass substrates.

It is to be understood that technical problems to be solved by the present disclosure are not limited to the aforementioned technical problems and other technical problems which are not mentioned will be apparent from the following description to a person with an ordinary skill in the art to which the present disclosure pertains.

According to one embodiment of the present disclosure, a laser sealing device for glass substrates includes a first laser head for irradiating laser onto a sealing material coated between glass substrates, thereby melting the sealing material; and a second laser head provided at a predetermined interval from the first laser head, the second laser head irradiating laser onto the portion which has been irradiated by the first laser head, the second laser head being set to a lower power than the first laser head.

The laser sealing device may further include a heating plate provided so as to be movable relative to the first and second laser heads and placed on the glass substrates when being heated to a predetermined temperature.

The beam size of the second laser head may be formed larger than that of the first laser head.

The beam size of the second laser head may be three times larger than that of the first laser head.

A first spot formed by the laser irradiated from the first laser head may be formed identical to or smaller than the width of the sealing material.

A second spot formed by the laser irradiated from the second laser head may be formed adjacent to the first spot formed by the laser irradiated from the first laser head.

The first and second laser heads may be provided to be inclined at a predetermined angle with respect to the glass substrates.

The sealing material may be a glass frit.

The second laser head may further include a hot air and IR lamp for post-heating the sealing material as a sealing heat source.

The laser sealing device may further include a pressurizing device for pressurizing an upper surface of the glass substrates.

The pressurizing device may be a pressurizing jig provided with a plurality of pressurizing pins supported thereto by an elastic force.

### BRIEF DESCRIPTION OF THE DRAWINGS

FIG. 1 is a graph showing changes in the temperature of a conventional sealing material.

FIG. 2 is a configuration view schematically showing a laser sealing device for glass substrates according to embodiment of the present disclosure.

FIG. 3 is a plan view schematically showing a state that laser is irradiated onto a sealing material according to the embodiment of the present disclosure.

FIG. 4 is a graph showing changes in temperature of the sealing material according to the embodiment of the present disclosure.

FIG. 5a is a photograph showing a state after conventional glass substrates are subjected to laser sealing.

FIG. 5b is a photograph showing a state after the glass substrates are subjected to laser sealing according to the embodiment of the present disclosure.

### DETAILED DESCRIPTION

A laser sealing device for glass substrates according to an embodiment of the present disclosure will now be described in detail with reference to the drawings.

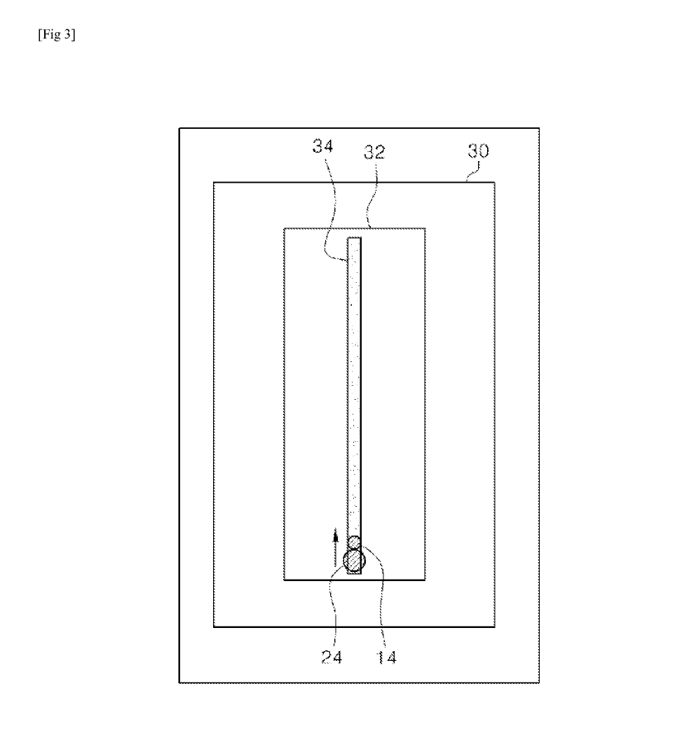

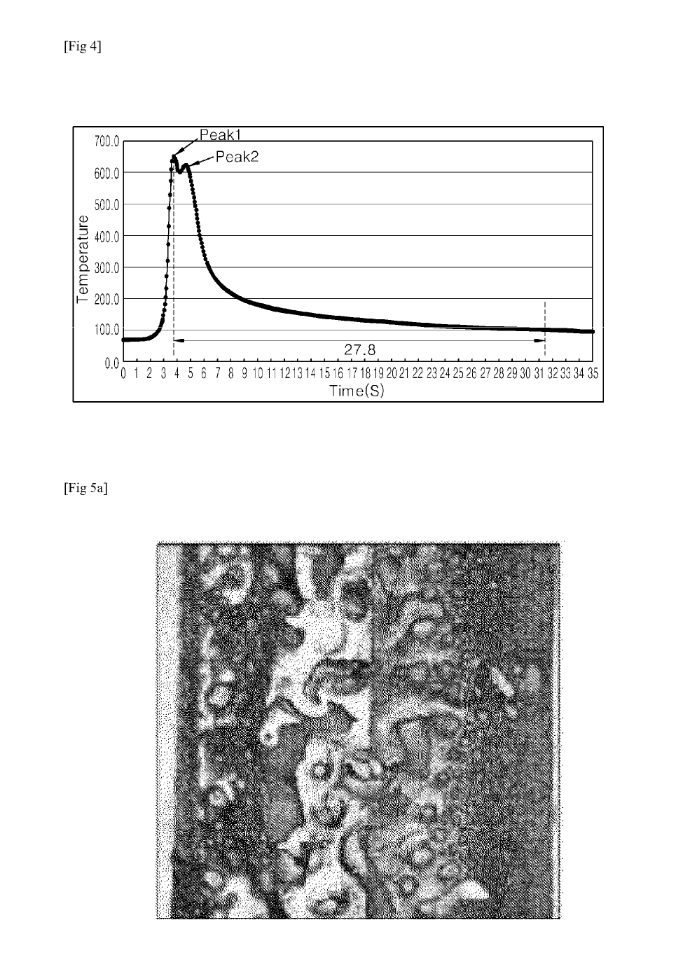

FIG. 2 is a configuration view schematically showing a laser sealing device for glass substrates according to embodiment of the present disclosure. FIG. 3 is a plan view schematically showing a state that laser is irradiated onto a sealing material according to the embodiment of the present disclosure. FIG. 4 is a graph showing changes in temperature of the sealing material according to the embodiment of the present disclosure.

As shown in these figures, the laser sealing device includes a first laser head 10 and a second laser head 20. The first laser head 10 irradiates laser onto a sealing material 34 coated between glass substrates 32, thereby melting the sealing material 34. The second laser head 20 is provided at a predetermined interval from the first laser head 10, and irradiates laser onto the portion which has been irradiated by the first laser head 10. The second laser head 20 is set to a lower power than the first laser head 10.

The first and second laser heads 10 and 20 are portions that irradiate laser onto the sealing material 34 so as to melt the sealing material 34. Each of the first and second laser heads 10 and 20 is provided to be inclined at a predetermined angle with respect to the glass substrates 32. The first and second laser heads 10 and 20 are also provided to make a predetermined angle, e.g., an angle of about 30° therebetween. Cables 12 and 22 are connected to one sides of the respective first and second laser heads 10 and 20 so as to receive power supplied therethrough.

In this embodiment, the first laser head 10 is used as a main sealing heat source for heating and melting the sealing material 34, and the second laser head 20 is used as an auxiliary sealing heat source for preventing the sealing material 34 heated by the first laser head 10 from being quickly cooled down. The second laser head 20 further includes a sealing heat source such as a hot air and IR lamp for post-heating the sealing material 34.

To this end, the first laser head 10 is set to a higher power than the second laser head 20. That is, the temperature of the laser irradiated by the first laser head 10 is set higher than that of the laser irradiated by the second laser head 20. If the first laser head 10 first heats the sealing material 34 to a high temperature, the second laser head 20 continuously heats the sealing material 34 to a slightly lower temperature than that of the first laser head 10 so as to prevent the sealing material 34 from being quickly cooled down.

In order to prevent the sealing material 34 from being quickly cooled down, the beam size of the second laser head 20 is formed larger than that of the first laser head 10. The beam size of the first laser head 10 is formed identical to or smaller than the width of the sealing material 34, which is illustrated in FIG. 3.

If the beam size of the second laser head 20 is larger than that of the first laser head 10, the second laser head 20 heats not only the sealing material 34 but also surroundings of the sealing material 34. Thus, it is possible to more effectively prevent the sealing material 34 from being quickly cooled down.

Here, the beam size of the second laser head 20 is preferably formed about three times larger than that of the first laser head 10. This is because when the beam size of the second laser head 20 is smaller than the three times that of the beam size of the first laser head 10 it is insufficient to prevent the sealing material 34 from being quickly cooled down, and it takes much time to cool down the sealing material 34 when the beam size of the second laser head 20 is larger than the three times that of the beam size of the first laser head 10.

As described above, the second laser head 20 is used as an auxiliary sealing heat source, so that it is possible to prevent the sealing material 34 from being quickly cooled down, thereby minimizing the occurrence of cracking in the glass substrates 32.

Meanwhile, the first and second laser heads 10 and 20 are provided at a predetermined interval so that the sealing material 34 can be continuously irradiated with the laser. To this end, a first spot 14 and a second spot 24 are preferably formed adjacent to each other. Here, the first spot 14 is formed by the laser irradiated from the first laser head 10 and the second spot 24 is formed by the laser irradiated from the second laser head 20.

That is, if the first and second spots 14 and 24 are formed adjacent to each other as shown in FIG. 3, the sealing material 34 can be continuously irradiated at the first and second spots 14 and 24. The positions of the first and second spots 14 and 24 may be set by adjusting the interval and angle between the first and second laser heads 10 and 20. The first and second spots 14 and 24 are changed depending on the beam sizes of the first and second laser heads 10 and 20, respectively. The second spot 24 is formed larger than the first spot 14.

In the present invention, the laser sealing process is performed through the glass substrates 32 placed on a heating plate 30. The heating plate 30 is a plate which has been previously heated to a predetermined temperature, and serves as an auxiliary sealing heat source of each of the first and second laser heads 10 and 20. That is, since the heating plate 30 is heated to the predetermined temperature, the heating plate 30, together with the second laser head 20, prevents the sealing material 34 coated between the glass substrates 32 from being quickly cooled down.

The heating plate 30 is provided to be movable relative to the first and second laser heads 10 and 20. That is, the first and second laser heads 10 and 20 are fixedly provided, and the heating plate 30 moves relative to the first and second laser heads 10 and 20, thereby irradiating the laser. The heating plate 30 may be provided to be movable, for example, using a driver source such as a stepping motor. It will be apparent that the heating plate 30 is not necessarily provided to be movable relative to the first and second laser heads 10 and 20. For example, the heating plate 30 may have a configuration in which the heating plate 30 is fixedly provided, and the first and second laser heads 10 and 20 move along the heating plate 30 on the heating plate 30.

The glass substrates 32 bonded through the process described above may be used in various fields. For example, the glass substrates 32 function to prevent an electrolyte from being leaked in a BIPV module, to prevent a discharge gas from being leaked in a PDP panel, and to prevent an organic luminescent material from being changed in an OLED panel, and to maintain a high degree of vacuum for a long period of time in double vacuum glass. The glass substrates 32 essentially maintain the degree of vacuum through the sealing process described above.

In this embodiment, a glass frit that is a ceramic or glass bonding material is preferably used as the sealing material 34. The glass frit has a sealing performance superior to a polymer adhesive. As shown in FIG. 2, the sealing material 34 is coated along the glass substrates 32 on a straight line for the purpose of sealing the glass substrates 32.

Meanwhile, the laser sealing device further includes a pressurizing device for pressurizing the glass substrates 32. The pressurizing device pressurizing an upper surface of the glass substrates 32, so that it is possible to prevent the glass substrates 32 from being separated from each other in the sealing process and to allow the glass substrates 32 to be more effectively bonded to each other.

In this embodiment, the pressurizing device is composed of a pressurizing jig 40 and pressurizing pins 42 supported to the pressurizing jig 40 by an elastic force. The pressurizing jig 40 is formed along the length direction of the glass substrates 32, and the plurality of pressurizing pins 42 are provided at a predetermined interval to the pressurizing jig 40. For example, a spring is provided to a rear end of each of the pressurizing pins 42 so that the pressurizing pins 42 have the elastic force toward the glass substrates 32.

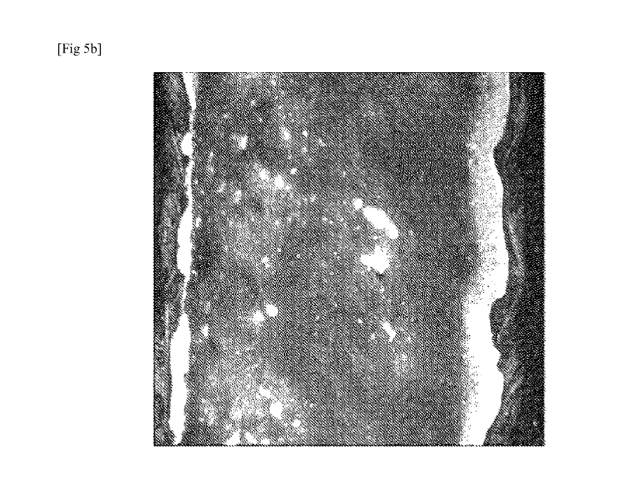

Hereinafter, an operation of the laser sealing device according to this embodiment will now be described in detail with reference to FIGS. 4, 5a and 5b.

As described above, the second laser head 20 is set to a lower power than the first laser head 10 so as to prevent the occurrence of cracking in the glass substrate 32 in the sealing process of the glass substrate 32.

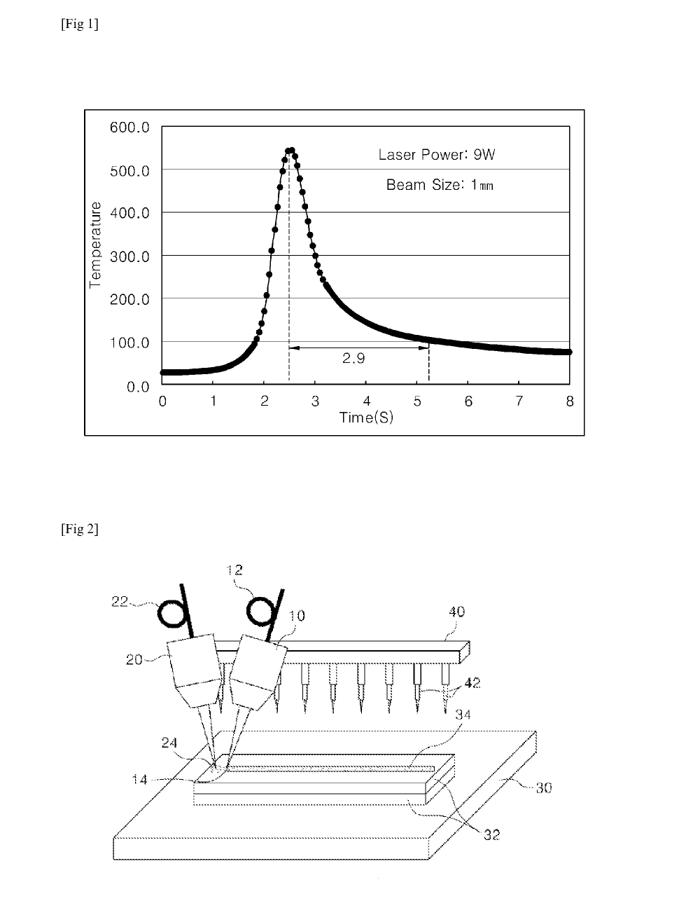

The change in temperature of the sealing material 34 heated by the laser sealing device configured as described above is shown in FIG. 4. Referring to this figure, the sealing material 34 initially maintains a temperature identical to that of the heating plate 30. That is, it can be seen that while the temperature of the sealing material 34 is initially maintained at about 30° C. in FIG. 1, the temperature of the sealing material 34 is maintained at about 70° C. which is the temperature of the heating plate 30 in the present invention. A separate glass substrate 32 is placed on an upper surface of the glass substrate 32.

The pressurizing jig 40 descends in the state that the glass substrates 32 are overlapped with each other, and the pressurizing pins 42 pressurize one side of the glass substrates 32 so that the glass substrates 32 can be well sealed with each other.

In this state, the first and second laser heads 10 and 20 sequentially irradiate laser onto the sealing material 34. If the laser is irradiated by the first and second laser heads 10 and 20, the temperature of the sealing material 34 rises rapidly. The temperature of the sealing material 34 rises up to about 660° C. by the laser irradiated by the first laser head 10.

Next, after the first laser head 10 has just passed, the temperature of the sealing material 34 rapidly drops as low as about 60° C. However, since the first laser head 10 irradiates the laser onto the sealing material 34 and the second laser head 20 continuously irradiates the laser onto the sealing material 34, the temperature of the sealing material 34 rises up to about 630° C. and then drops.

It can be seen that while it takes 2.9 seconds for the temperature of the sealing material 34 to drop to about 100° C. in FIG. 1, it takes 27.8 seconds for the temperature of the sealing material 34 to drop to 100° C. in this embodiment. In this embodiment, since the temperature of the sealing material 34 does not drop rapidly but drops slowly, it is possible to minimize the occurrence of cracking in the glass substrates 32 due to thermal shock and to improve the durability of the glass substrates 32.

Referring to FIGS. 5a and 5b, the occurrence of cracking in the glass substrate (b) of the present invention is remarkably reduced as compared with that in the conventional glass substrate (a).

According to the present disclosure in some embodiments, it is possible to provide a laser sealing device for glass substrates, in which two laser heads are provided to irradiate laser, and a first laser head set to a higher power than a second laser head first irradiates laser onto a sealing material and the second laser head continuously irradiates laser onto the sealing material.

Thus, it is possible to minimize the occurrence of cracking in the glass substrates due to thermal shock since the temperature of the sealing material which is melted by the laser heads drops slowly rather than dropping rapidly. As a result, it is possible to improve durability of the glass substrates completed through the laser sealing.

While certain embodiments have been described, these embodiments have been presented by way of example only, and are not intended to limit the scope of the disclosures. Indeed, the novel methods and apparatuses described herein may be embodied in a variety of other forms; furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

1. A laser sealing device for glass substrates, comprising:
a first laser head for irradiating laser onto a sealing material coated between glass substrates, thereby melting the sealing material; and
a second laser head provided at a predetermined interval from the first laser head, the second laser head irradiating laser onto the portion which has been irradiated by the first laser head, the second laser head being set to a lower power than the first laser head.

2. The laser sealing device of claim 1, further comprising a heating plate provided so as to be movable relative to the first and second laser heads and placed on the glass substrates when being heated to a predetermined temperature.

3. The laser sealing device of claim 2, wherein the beam size of the second laser head is formed larger than that of the first laser head.

4. The laser sealing device of claim 3, wherein the beam size of the second laser head is three times larger than that of the first laser head.

5. The laser sealing device of claim 2, wherein a first spot formed by the laser irradiated from the first laser head is formed identical to or smaller than the width of the sealing material.

6. The laser sealing device of claim 2, wherein a second spot formed by the laser irradiated from the second laser head is formed adjacent to the first spot formed by the laser irradiated from the first laser head.

7. The laser sealing device of claim 2, wherein the first and second laser heads are provided to be inclined at a predetermined angle with respect to the glass substrates.

8. The laser sealing device of claim 2, wherein the sealing material is a glass frit.

9. The laser sealing device of claim 2, wherein the second laser head further comprises a hot air and IR lamp for post-heating the sealing material as a sealing heat source.

10. The laser sealing device of claim 1, further comprising a pressurizing device for pressurizing an upper surface of the glass substrates.

11. The laser sealing device of claim 10, wherein the pressurizing device is a pressurizing jig provided with a plurality of pressurizing pins supported thereto by an elastic force.
